(19) United States
(12) Patent Application Publication
(10) Pub. No.: US 2026/0346068 A1
(43) Pub. Date: Nov. 5, 2026

(54) SELF-CONTAINED FIRE SUPPRESSION SYSTEM WITH CONTROLS

(71) Applicant: Jesse P. Van Horn, Granite Bay, CA (US)

(72) Inventors: Jesse P. Van Horn, Granite Bay, CA (US); Chad M. Wall, Livermore, CA (US); Josh Sybrowsky, Lincoln, CA (US); Steven Frazier, Orangevale, CA (US)

(21) Appl. No.: 19/668,245

(22) Filed: May 5, 2026

Related U.S. Application Data
(60) Provisional application No. 63/800,061, filed on May 5, 2025.

(51) Int. Cl. A62C 25/00; A62C 3/02; A62C 31/00; A62C 37/36; A62C 37/50

(52) U.S. Cl. CPC A62C 25/005; A62C 3/0214; A62C 31/005; A62C 37/04; A62C 37/50

(57) ABSTRACT

A firefighting fluid reservoir is supported upon a base. The base also supports a main pump and pump powering subsystems, as well as firefighting fluid recirculation subsystems, preferably contained within a cabinet above the base. A main shelf beneath the cabinet is located above a portion of the reservoir. Firefighting fluid health is at least partially maintained by the recirculation subsystem. The reservoir includes outer walls with integrated ribbing and forklift slots and handles and is formed with or secured to the base to facilitate reservoir handling and structural rigidity/integrity. An exhaust subsystem manages exhaust from a fuel combustion motor powering the main pump, if the motor is powered by fuel combustion, rather than being an electric motor. A telemetry subsystem including antennas, controls, control signal wiring and sensors to assist in control of the system. Multiple units of the system can be interconnected together for expandability.

### CROSS-REFERENCE TO RELATED APPLICATIONS

This application claims benefit under Title 35, United States Code §119(e) of United States Provisional Application No. 63/800,061 filed on May 5, 2025.

### FIELD OF THE INVENTION

The following invention relates to fire suppression systems which can project a firefighting fluid onto a fire or a structure to be protected from a fire or fuel between a fire and the structure. More specifically, this invention relates to fire suppression systems which include their own fluid reservoir and pump and hose for delivery of firefighting fluid without requiring interconnection with other firefighting equipment or transport to a firefighting location.

### BACKGROUND OF THE INVENTION

Various liquids are useful for fire suppression, including water alone; water with various additives such as fire retardant additives, and/or polymer gel emulsion; or other non-water liquids. Such liquids can be used in advance of an approaching fire, to cause surfaces treated with such liquids to be less combustible and/or can be used directly upon flames or structures which are burning.

Generally, the more valuable a structure is, the more desirable it is to provide systems, methods and equipment to keep such structures from being damaged by fire. Other factors such as whether or not a structure is a residence or other habitation, or if the structure is of some critical nature, can also cause a structure to be prioritized for fire defense. With residences, as well as other high priority fire defense structures, a primary fire defense in the prior art has been to rely upon firefighting personnel in the community to utilize their professional equipment for fighting fire. While there are certainly benefits to leaving the dangers of fighting fire to professionals, there are circumstances where it is beneficial to have additional equipment and methods at the disposal of an owner of a residence or other critical structure, for use in circumstances where professional firefighting personnel are less available than desired. Such equipment can also be of benefit to professional firefighters when they arrive on the scene of a fire.

Circumstances exist where professional firefighting personnel might be less able to fully and adequately fight a residential fire. For instance, when wildfire adjacent to a large number of structures, such as residences, is rapidly approaching, professional firefighting resources can be overwhelmed. While the professional firefighters do the best they can to protect residences and other structures from the approaching wildfire, and to fight the fire when it is at an early stage and able to be extinguished, the effectiveness of such efforts is a function of the number of structures threatened and the number of professional firefighters and the amount of professional equipment at their disposal. Simple math dictates that in certain circumstances some structures will be left undefended or inadequately defended.

Firefighting equipment known in the prior art comes in a variety of different forms. Some firefighting equipment is in the form of a portable fire extinguisher, which includes a reservoir of fluid or solid powder, typically maintained under pressure and with a valve and nozzle. A user manually operates the valve to dispense a firefighting agent from the reservoir and out of the nozzle at the fire to extinguish the flames. Such portable systems are limited in the amount of firefighting agent they can contain, in that they must remain portable. Wheeled carts or vehicles can amplify the volume of such systems somewhat.

It is also known to provide pumps such as submersible pumps, which are gas powered, and which can be utilized next to an available water source, such as a swimming pool or pond, and which can have fire hoses connected thereto. While such pumps are typically utilized by professional firefighters, they can also be utilized by owners of residences or other valuable structures, especially when a known water reservoir is nearby which can be utilized. Such systems require the availability of such a reservoir, which is often not readily available. Furthermore, a distance from the available reservoir to the residence or other structure to be defended can be a variable, which causes each such circumstance to require separate evaluation, with such positioning in many instances being less than optimal for defending the residence or other structure.

Another factor in the effectiveness of such systems is the potential elevation difference between the available reservoir and the structure to be defended. Not only does a lower reservoir require a greater amount of power in the pump to provide the required pressure at the location of the structure to be defended, but also any inlet lines leading to the pump from the reservoir cannot exceed or approach limits associated with atmospheric pressure, which can cause the pump to be inoperable. Accordingly, a need exists for a firefighting system which solves this problem of managing the difficulties associated with finding an appropriate reservoir, positioning the pump adjacent to the reservoir and activating such systems. This problem is especially acute because when a fire event is occurring, time is critical and decisions can be difficult to make in the moment, due to the stress involved.

Other known prior art residence and other structure firefighting systems include sprinkler systems which can mount to roofs or near roofs or other portions of a structure. Such systems are known which utilize available water lines and feed sprinklers which can direct water onto the structure. These sprinklers can be prepositioned, such as during fire season in a wildfire prone area or otherwise built into the structure or resting upon the roof of the structure.

Such systems require that water pressure be available during a fire event. Reliability of water pressure varies, and can be risky to rely upon, with such risks being magnified during a fire event. Some water systems pressurize the water with some form of electric power, such as a pump within the water supply system, and often power outages accompany fires. Such power interruption can thus cause loss of water pressure. Furthermore, such sprinkler based systems generally provide a lower flow of water than desired, and are not able to be directed most optimally for fire defense when compared to a nozzle of a fire hose, which can be held and pointed by a user in a most effective manner, factoring in wind, location of the fire and other factors.

### SUMMARY OF THE INVENTION

With this invention, a fire defense system is provided which is a fully self-contained portable modular unit which has all of the elements necessary to provide a high-pressure stream of liquid firefighting agent from the fire defense system, whenever needed, and done without requiring any set up whatsoever.

The system includes a reservoir for liquid firefighting agent contained within an enclosure. A main pump is mounted to the enclosure with the pump powered by a motor. The enclosure is configured to have the motor and pump supported thereon, and typically upon a common base, to provide an overall portable self-contained firefighting system. The system is also modular to allow for multiple systems to be connected together to enhance available reservoir volume. Simpler reservoir only subsystems can be utilized as auxiliary units to the primary units, which auxiliary units merely omit the pump and motor and allow for multiplication of the volume of firefighting agent available with such an expanded modular system and subsystems combined together.

In one example embodiment disclosed herein, the base is particularly configured to include fork slots therein to allow for a forklift to conveniently move the enclosure of the reservoir. In one embodiment, these fork slots extend in two different mutually perpendicular directions in the base, to allow for the enclosure to be accessed from a forklift from two separate perpendicular directions, such as either from the east or the south, for instance. The base has a lower surface which is ruggedized to rest upon various different surfaces, including bare ground, vegetation, concrete, or other underlying surfaces. The base is also configured to be sufficiently structurally designed to support the weight of the enclosure as well as the motor and pump, and when the enclosure is filled with the liquid firefighting agent.

The enclosure of the reservoir rests upon this base (or can have the base integrated into the enclosure, such as for enhanced strength and efficiency). In one embodiment, the base is square or rectangular in shape and the enclosure has side walls and end walls which fit within the footprint of the underlying base, thus causing the enclosure to be square or rectangular in horizontal cross-section, and when viewed in a plan view. Thus, the enclosure generally has substantially vertical side walls and a vertical rear end wall and a vertical front end wall (other than a shelf therein). The enclosure also preferably includes a horizontal upper surface which is generally parallel with a lower surface of the enclosure.

In one example embodiment, the lower surface is slightly tapered and includes a sump at one end thereof, such as at the front end. With such a taper, when the enclosure is resting upon a horizontal surface, liquids will flow to the sump so that substantially all of the firefighting agent within the reservoir can be utilized by the system of this invention. By providing the upper surface as horizontal, this facilitates vertical stacking of the separate modular units, such as during storage and when empty. Furthermore, by providing the units with a rectangular or square footprint, they can be stacked close together horizontally with other similar units in a dense configuration to minimize the footprint of such units during storage and use.

In one example embodiment, the front end of the enclosure includes a shelf having a horizontal orientation and oriented above the lower surface and below the upper surface. This shelf is preferably oriented above the sump and provides support for the motor and pump. An intake of the pump extends down into the sump, allowing for firefighting agent to be drawn up into the pump and expelled from the pump and feeding a hose or other output. The hose would typically be of a length such as 50 or 100 feet and with a nozzle at an end of the hose opposite the pump. In one embodiment, a unit can support both 3/4 inch and one inch diameter hose. The main pump can support multiple hoses simultaneously, such as with use of Y valves, all hoses/nozzles spraying at once. A valve can be integrated into the nozzle or adjacent to the nozzle. Other and greater length of hose could also optionally be provided. Sizing for the hose (length and diameter) and pump can vary based on the overall sizing of the system.

The pump and motor are preferably provided with a footprint no larger than the shelf and no taller than a spacing between the shelf and the upper surface of the enclosure. In this way, the pump and motor are contained within an overall footprint and lateral boundaries of the enclosure and allowing for close parking of the similar units adjacent to each other and without interference. Furthermore, the pump and motor are protected somewhat from damage by maintaining their footprint no larger than the shelf.

In one embodiment, space upon the shelf is contained within a cabinet including an access door. The pump and motor can be contained within this cabinet, with the cabinet provided to keep pests out of this space and to otherwise secure this equipment. Other equipment contained within this cabinet or nearby can include a fuel reservoir if the motor is a hydrocarbon fuel powered motor, as well as control system electronics and valves and switches, levers, knobs, etc. for operating the system.

The door can include a lock thereon which can only allow opening by individuals with appropriate security credentials, such as possession of a key or knowledge of a code, so that only authorized personnel can turn on the system, such as turning on the motor and/or accessing valves of the system and/or turn on the pump. In one embodiment, a firefighter access key can be provided on the cabinet door, similar to that associated with a firefighter access lock and key system utilized in many jurisdictions, such as on locks on private gates which allow firefighter access through such private gates. In this way, professional firefighting personnel can quickly and easily utilize the system of this invention without first contacting the owner. In other embodiments, unlocking can be fully or partially controlled remotely, such as from an app that can authorize a user and communicate to the unit a door unlock command. A user and/or emergency personnel could use such an app to unlock (and otherwise monitor and control) each unit.

In one embodiment, the enclosure is a plastic molded enclosure. To give the enclosure sufficient rigidity, and also minimize material utilized in injection molding or otherwise forming the enclosure, the enclosure can include stiffening ribs thereon. In one embodiment, such stiffening ribs are provided in side walls and the upper surface of the enclosure. The base, whether separate from or incorporated into the enclosure, can also optionally be made of molded hydrocarbon material and with appropriate gussets and positioning of walls to give the base the requisite strength and resistance to deformation, especially when the enclosure is filled with liquid firefighting agent.

The motor can in one embodiment be a combustion engine configured to run on a hydrocarbon fuel. For instance, the motor could run on gasoline or diesel fuel, or be powered by propane or liquid petroleum, gas or other hydrocarbon fuel. In such a configuration, an exhaust pipe would also be provided which would lead out of the cabinet. In one embodiment, the exhaust pathway includes a fan thereon to fully remove exhaust from the cabinet area and also drive flow into the cabinet. In one embodiment, the exhaust path is out a bottom of the enclosure and away from the cabinet. The exhaust fan evacuates exhaust and also helps to cool electronics and other equipment in the cabinet.

Furthermore, hot surfaces of the combustion engine would be spaced away from walls of the enclosure to prevent melting or other damage to the enclosure. If needed, thermal insulation could be provided between the combustion engine and a wall of the enclosure (and the shelf) adjacent to the combustion motor to protect the enclosure from damage. Such a combustion motor could have a pull start or could have a battery and an electric start in various different embodiments.

As an alternative, the motor could be an electric motor powered by a battery (or optionally powered from some other electric power source). If powered by a battery, preferably the battery and electric motor would all be supported upon the shelf and contained within the overall footprint of each modular unit. As an alternative, a separate battery structure could be provided and electrically coupled to the electric motor.

In one embodiment, the motor is a gas motor, but a separate electric motor is provided merely to run a recirculating pump adjacent to or within the enclosure. Many firefighting liquid agents require periodic mixing to ensure that they avoid stratification, precipitation, or other transitions which can affect the effectiveness (and health) of the firefighting agent. In one embodiment, a recirculation inlet and outlets are provided passing into the enclosure and also coupled to the recirculation pump. This electric recirculation pump could run off of a battery or receive electric power from some other source. It is also conceivable that the recirculation pump could take power from the combustion engine, such as from a common power takeoff, which is also powering the pump, or an auxiliary power takeoff. Such power could be in the form of shaft power and could occur through a transmission which would allow for engagement/disengagement either in an automated or manual fashion.

In one embodiment, recirculation occurs between a primary enclosure and auxiliary enclosures associated with other modular units, which may or may not have a pump and motor associated therewith. Such interconnection of multiple reservoirs typically occurs with two hoses or other conduits, one leading from a primary reservoir to an auxiliary reservoir and the other leading from the auxiliary reservoir back to the primary reservoir. The recirculating pump can be put along one of these conduits to cause recirculation to occur between the reservoirs. In one embodiment, periodic recirculation pump activation occurs, such as based on a timer, so that the firefighting agent remains ready to perform its function at all times.

In one example embodiment, a temperature sensor is provided within or adjacent to the reservoir to monitor temperature of the firefighting agent. If the temperature drops below a desired minimum level, an electric heat source in the base or otherwise associated with the reservoir or fluid conduits can be activated to maintain a minimum temperature for the firefighting agent. In one embodiment, such electric heat source includes electric resistance heating pads, which function by having electric current routed therethrough from the battery associated with the recirculating pump (or the battery associated with the primary motor, which powers the main pump if this primary motor is an electric motor).

Other automated controls can include controls which automatically start the primary motor periodically to recirculate lubricants and ensure ongoing proper functioning of the combustion engine or other motor. Such controls can also monitor these periodic running cycles, and if any parameters exceed safe limits, the control system can provide an output signal to service personnel. This output signal could merely energize a warning light on the cabinet or elsewhere within the system, or can be in the form of a communications device, which can send a wireless communication signal to authorized personnel notifying them that the unit requires servicing.

As a further or alternative option, such units as those disclosed could be professionally serviced such as by servicing personnel which periodically visit the site where the unit is located, start up the unit, ensure that is working properly, and then certify that such regular servicing has occurred. In this way, the units are ready to perform their necessary function at all times. Options for wireless communication with the units can include cellular tower communication, 900 MHz communication with the telephone system within an adjacent residence or other structure, Wi-Fi type wireless communication, Bluetooth communications direct to satellite communication (such as through Starlink satellite terminals), or other wireless radio frequency or other communications protocols. Typically communications such as by emergency personnel, will be with the units, managed remotely through an app with the app running on a computer or smartphone or other device.

Other sensors which can be included in the system can include sensors measuring how full the reservoir is, such as so that maintenance personnel can monitor whether or not the enclosures are full without a site visit. The unit can also be fitted with an emergency strobe which is activated either from a remote signal received from an authorized individual or by an individual present at the unit, which emergency strobe can communicate to emergency firefighting personnel and to homeowners and others the availability of the unit in an emergency firefighting situation. Also, notifications can be sent in such situations to designated persons, such as homeowners, neighbors and responders. These notifications can occur via email, simple messaging system (SMS) “text” messages, phone calls or other modes of communication.

In use and operation, and with continuing reference to the disclosure provided above, the system of this invention is utilized according to the following method, as one possible example. Initially, a location is identified for placement of the unit. A forklift can be utilized to place the unit where desired. As an option, and with the enclosure empty, the unit can merely be picked up and handled by an individual or group of individuals and placed where desired. Typically, placement will involve a location which is close enough to the structure to be defended from a fire event, that a length of the hose can reach all portions of the structure. The user will then fill the reservoir with firefighting agent (and fill any fuel tanks). Examples of firefighting agents include water alone or water with an included firefighting agent or some non-water substitute. Examples of firefighting agents can include water with a fire retardant chemical additive and/or water with a polymer gel emulsion additive.

Once the reservoir has been filled, the unit is ready for operation. When a fire event occurs, a user merely opens the cabinet, turns on a starter switch for the motor and the motor comes to life and the pump is energized. A user can then access a valve on the pump or a valve on the nozzle at the end of the hose, which is already hooked up to the pump, and commence discharging firefighting agent on the structure or against an approaching fire. When the fire event has subsided, the user can turn off the valve on the hose and turn off the motor. A user can then refill the enclosure, refill the fuel tank, and it is ready to be used again in the future.

### Objects Of the Invention

Accordingly, a primary object of the present invention is to provide a fire suppression system which is self-contained and can spray a firefighting fluid on or near a structure to be defended.

Another object of the present invention is to provide a self-contained fire suppression system which maintains a readiness state for rapid activation and use when needed.

Another object of the present invention is to provide a fire suppression system which includes a reservoir for firefighting fluid and a pump for discharge of firefighting fluid from the reservoir when needed, along with a power source, so that no active connection to a water source or power source is required.

Another object of the present invention is to provide a fire suppression system which is modular and can be readily transported and stored, as well as deployed in multiple units to provide desired capacity.

Another object of the present invention is to provide a self-contained fire suppression system which includes a recirculating system for the firefighting fluid to keep the firefighting fluid in proper condition for use when needed.

Another object of the present invention is to provide a method for fire suppression including utilizing one or more self-contained units, each including a reservoir for firefighting fluid and equipment for distribution of the firefighting fluid in fire suppression.

Another object of the present invention is to provide a self-contained fire suppression system which can be remotely monitored and controlled through associated sensors, controls and telecommunications.

Another object of the present invention is to provide a source of firefighting agent that can be manually applied from a hose or sprinklers, or can be coupled to built-in sprinkler systems which can be automatically actuated, such as during a fire event.

Other further objects of the present invention will become apparent from a careful reading of the included drawing figures, the claims and detailed description of the invention.

### BRIEF DESCRIPTION OF THE DRAWINGS

FIG. 1 is a perspective view of a series of units, each incorporating the system of this invention in use by firefighting personnel to defend a structure against a fire threat by applying firefighting fluid upon the structure and vegetation adjacent to the structure.

FIG. 2 is a full sectional view of one of the units of the system disclosed in FIG. 1.

FIG. 3 is a full sectional view similar to that of FIG. 2, but from the opposite side.

FIG. 4 is a perspective view from a front of one of the units of FIG. 1.

FIG. 5 is a side elevation view of one of the units of FIG. 1.

FIG. 6 is a front elevation view of one of the units of FIG. 1.

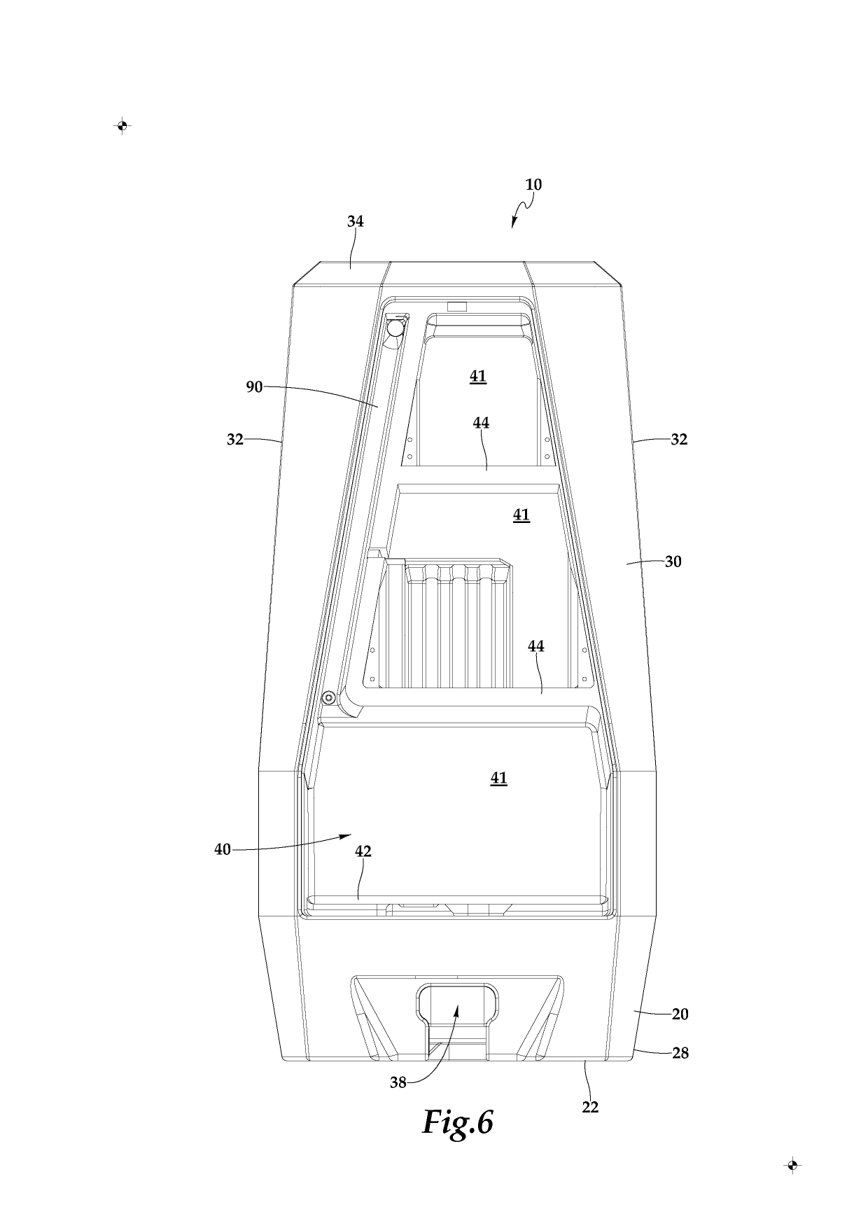

FIG. 7 is a perspective view from above of one of the units of FIG. 1.

FIG. 8 is a perspective view from below of one of the units of FIG. 1.

FIG. 9 is a full sectional view of one of the units of FIG. 1, showing firefighting fluid within an enclosure thereof.

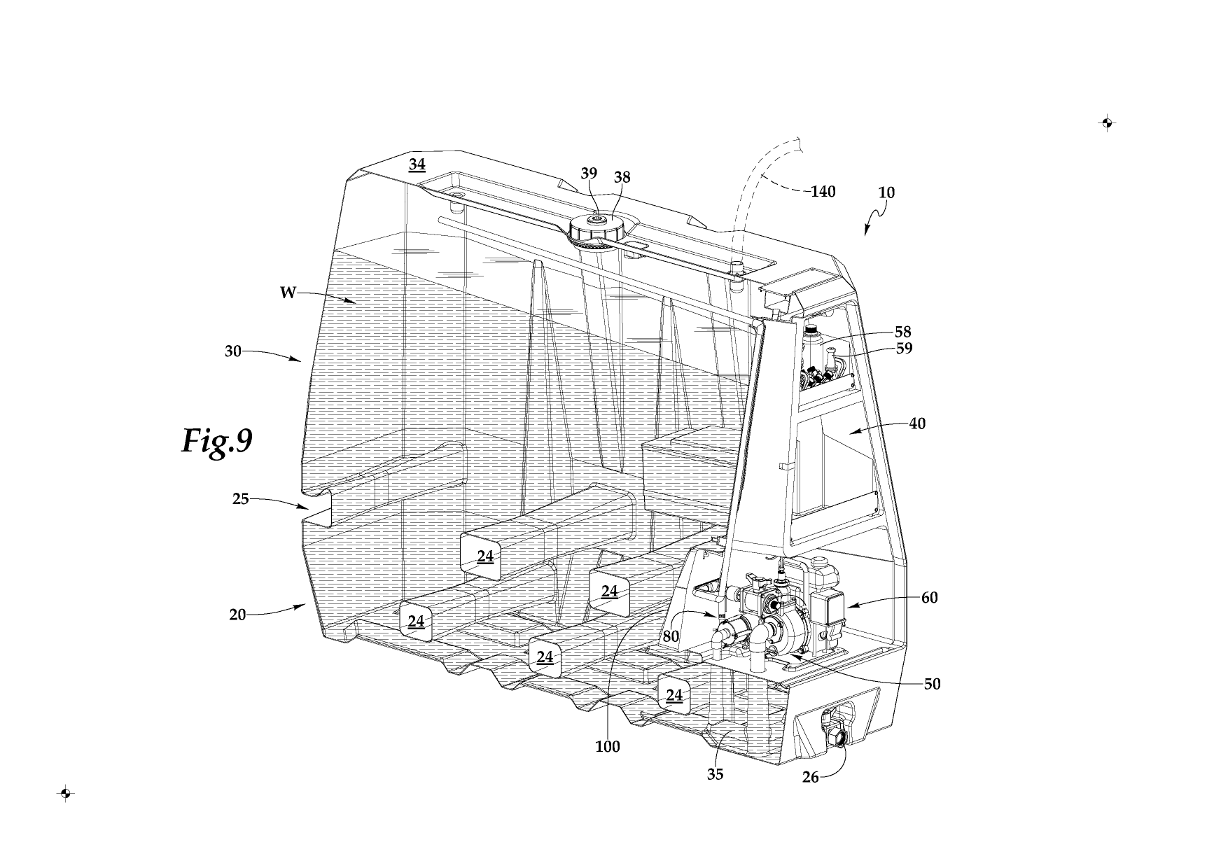

FIG. 10 is a perspective view of an enclosure for one of the units of the system of this invention, with forward portions of the enclosure cut away to reveal interior details.

FIG. 11 is a perspective view of that which is shown in FIG. 10 from a more rearward viewpoint than as shown in FIG. 10.

FIG. 12 is a perspective view similar to that which is shown in FIG. 11, except with rear portions of the enclosure cut away to reveal interior details.

FIG. 13 is a perspective view similar to that which is shown in FIG. 10, except with a forward half of the enclosure cut away to reveal interior details.

### DESCRIPTION OF THE PREFERRED EMBODIMENT

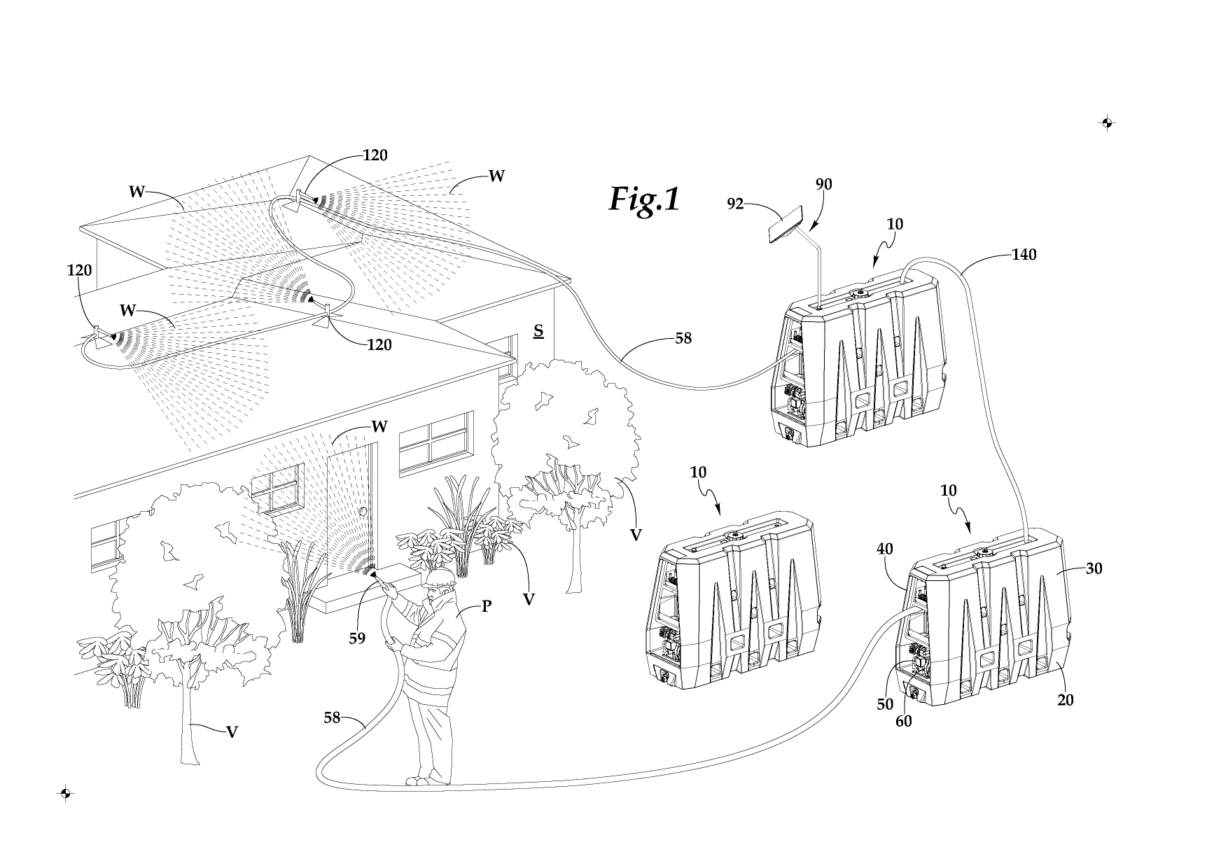

Referring to the drawings, wherein like reference numerals represent like parts throughout the various drawing figures, reference numeral 10 is directed to a system for fire suppression (FIG. 1) which is self-contained and allows for delivery of firefighting fluid W from a reservoir 30 of the system 10 upon or adjacent to a structure S (and vegetation V) to defend from a fire. The system 10 includes a basic layout and basic equipment, as well as subsystems that can optionally be incorporated into various example embodiments of the system 10 of this invention.

In essence, and with particular reference to FIGS. 1-3, basic details of the system 10 of this invention are described, according to one example embodiment. The system can be comprised of one or more separate units. A base 20 defines a portion of an overall enclosure and provides an underlying structure for one unit of the system 10, which can operate alone or as one unit within a multi-unit assembly. The base 20 supports a reservoir 30 thereupon. A cabinet 40 is incorporated into an outer enclosure of the system 10, adjacent to the reservoir 30 and in one embodiment over at least a portion of the reservoir 30. The cabinet 40 contains a main pump 50 and typically also an associated motor 60 for powering the main pump 50. An exhaust subsystem 70 manages removal of exhaust from the motor 60, should the motor 60 be a fuel combustion type motor 60. A recirculation subsystem 80 can also be contained within the cabinet 40 and manages health of the firefighting fluid W, such as through recirculating input/output of the firefighting fluid W to maintain mixing and other characteristics of the firefighting fluid W. A telemetry/control subsystem 90 includes at least one antenna 92 and control signal wiring 94, as well as a CPU 25 and sensors 96 configured to facilitate remote monitoring and control of the system 10. Auxiliary systems 10 can be added to the system 10 to expand a capacity of an overall assembly of systems 10 with associated equipment for interconnection of multiple such units.

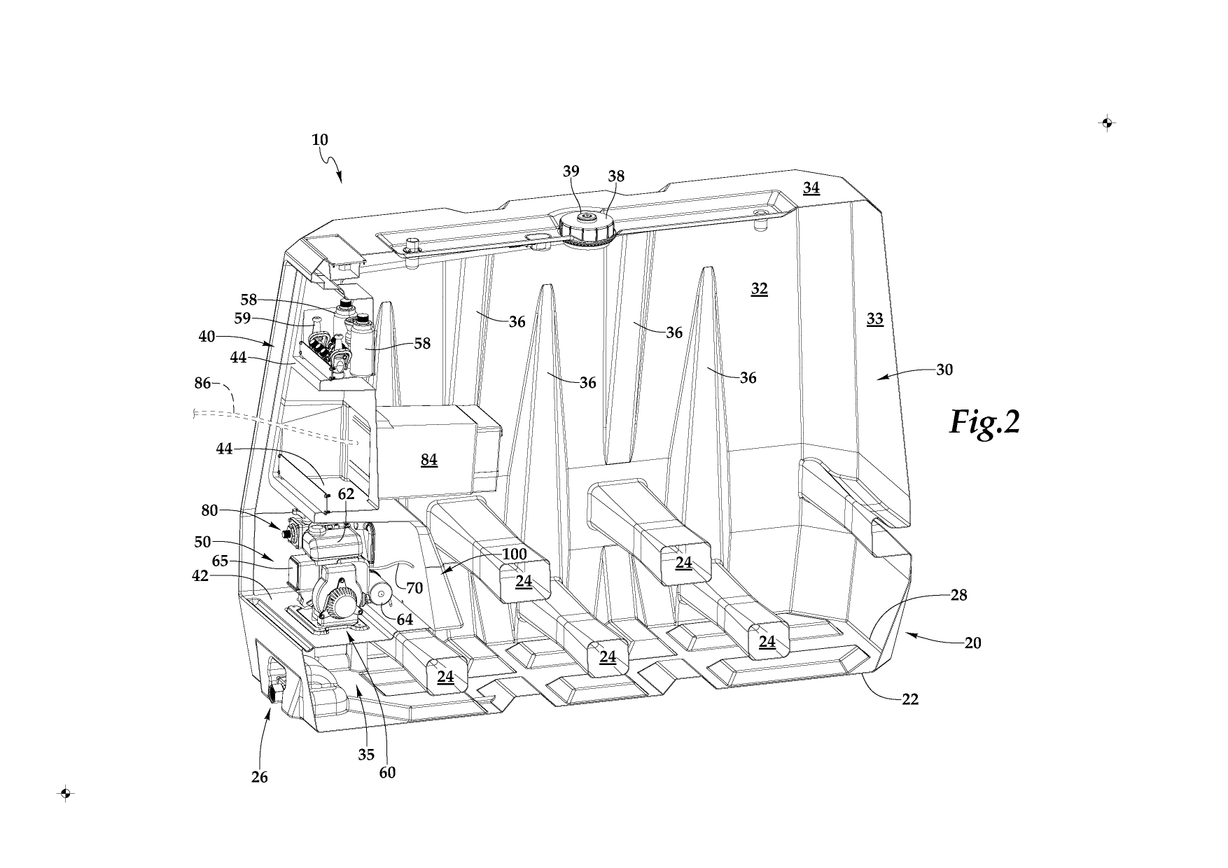

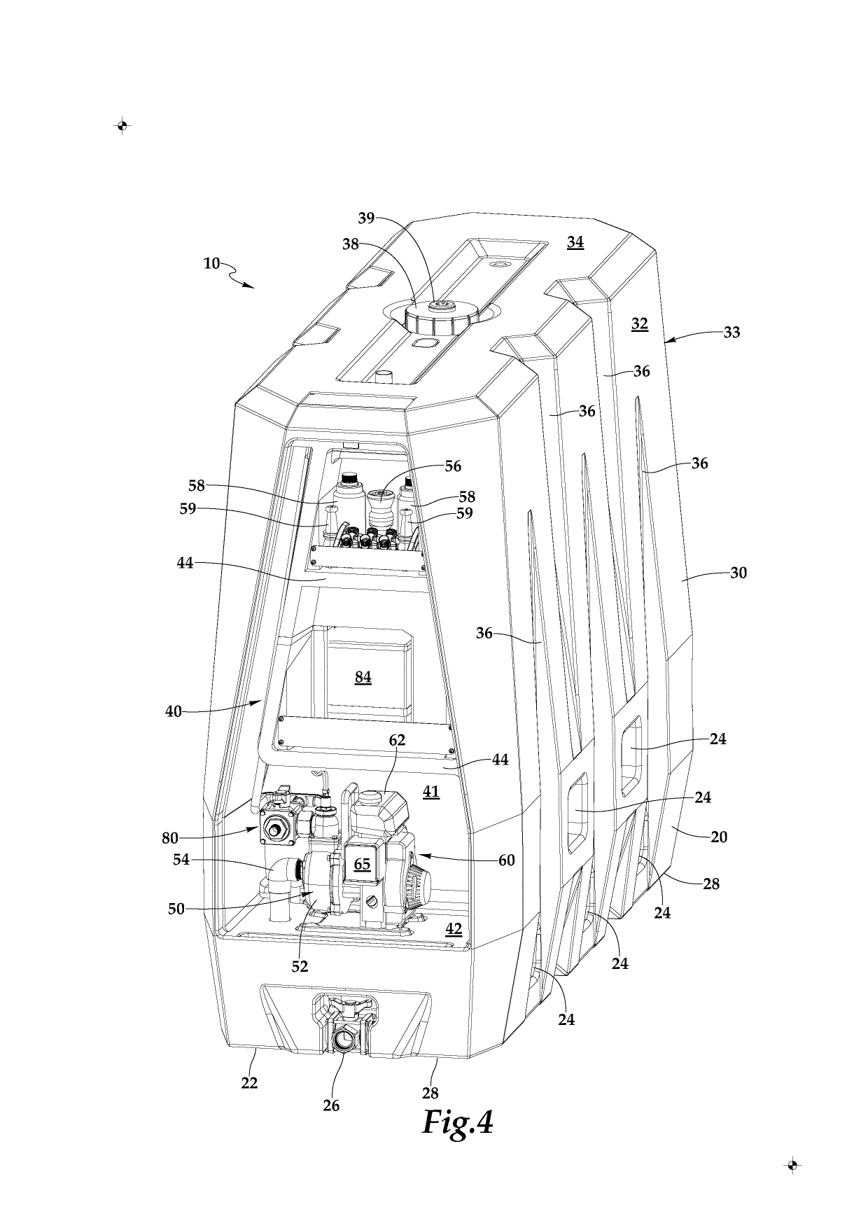

More specifically, and with continuing reference to FIG. 1 as well as FIGS. 2-5, further details of the basic configuration of the system 10 are described, according to one example embodiment. The base 20 defines a lowermost portion of each unit of the system 10, with as few as a single unit comprising the system 10 or multiple units together comprising the system 10. Each base 20 includes an under surface 22 which can rest upon an underlying surface and is typically flat, but could have feet for engaging an underlying surface. In one embodiment, the base 20 and reservoir 30 that is supported therein, transition without a discernible boundary therebetween.

The base 20 (or portions of the reservoir 30 near the base 20) preferably includes forklift slots 24 passing therethrough. These forklift slots 24 are typically a common height above the under surface 22 and pass entirely through the base 20, either between lateral sides 32 of the reservoir 30 or base 20 beneath the reservoir 30, or in a front to rear orientation parallel with the lateral sides 32. Spacing between these forklift slots 24 can match a standard of forklift tine spacing, to allow for convenient moving of a unit of the system 10 in a convenient manner with a forklift, with tines of the forklift passing through the forklift slots 24. The forklift slots 24 can be used with a strapping system, as an option, to facilitate movement of a unit as desired. The forklift slots also add rigidity to the base 20 and reservoir 30 in that they add additional surfaces to the unit which can resist various different loads encountered by each unit, such as when filled with differing amounts of firefighting fluid W.

In one embodiment shown, upper slots 24 are provided as one option for general engagement of the system 10 with a forklift. Lower slots 24 in this embodiment are presented as three equally spaced slots 24 at a common height. A front two of these slots are useful when the reservoir 30 is empty and a center of mass to the equipment in the cabinet 40 represents more of the total weight. The multiple slots also strategically reinforce the structure of the enclosure of the system 10.

The base 20 also typically includes some form of drain 26. In one embodiment, a lowermost portion of the reservoir 30 is in a sump 35 of the reservoir 30 beneath the cabinet 40 and near a front of the reservoir 30 opposite the rear 33. This drain 26 can have a cap and valve which is openable thereon to facilitate draining of firefighting fluid W from an interior of the reservoir 30. In one embodiment, the drain 26 is within a slot elevated up above the under surface 22 to facilitate access in the drain 26 and to keep the drain 26 from being blocked by ground upon which the under surface 22 of the base 20 is resting. The valve can be a three way valve so that plumbing feeding the drain can also function to feed the hose 58 or be part of the recirculation subsystem 80 and also facilitate opening the drain 26. The base 20 also includes a perimeter 28 surrounding a front, rear and lateral sides of the base 20. This perimeter 28 preferably extends from the under surface 22 up to where the base 20 transitions into the reservoir 30. In one embodiment, the base 20 has a generally rectangular form when viewed from above, but could have other shapes.

The base and reservoir 30 are typically formed together from a monolithic mass of injection molded or roto-molded or otherwise molded polymeric hydrocarbon material or other moldable or conformable material. As an alternative, each unit of the system 10 could be formed of multiple parts which are then joined together at a seam, typically including a gasket within mating gasket surfaces, and with fasteners (such as bolts) joining the two gasket surfaces together with a gasket sandwiched therebetween. With such a construction, options for manufacture of the base 20 and reservoir 30 could include machining, 3-D printing, injection molding, fiberglass layup, vacuum forming or other forming techniques.

The reservoir 30 extends up from the base 20 and generally includes the lateral sides 32 parallel and opposite each other, and spaced apart by a rear 33 and also spaced apart by a top surface 34 opposite the under surface 22 of the base 20. Preferably, the reservoir 30 includes a sump 35 defining a lowermost portion of the reservoir 30 on a portion of the reservoir 30 opposite the rear 33 and generally underneath and adjacent to the cabinet 40 at a front of the unit. The sump 35 is generally an interior detail of the reservoir 30 defining a lowermost portion of a floor of the reservoir 30, which can include this floor optionally sloping downwardly as it extends away from the rear 33 and under the cabinet 40 at a front of the unit.

An exterior of the reservoir 30 preferably includes ribbing 36 thereon. This ribbing in one embodiment extends generally vertically and breaks up an outer surface of the reservoir 30 into multiple separate facets, which are angled relative to each other. This ribbing 36 causes stiffening of the reservoir 30 and resistance to bulging of the reservoir, such as from loads associated with hydrostatic pressure of the firefighting fluid W within the reservoir 30. The ribbing 36 can have a variety of different shapes and forms with those depicted herein being one example. The ribbing 36 and forklift slots 24 work together to help to stiffen the reservoir 30 and base 20 of each unit of the system 10.

The top surface 34 (or portions of the reservoir near the top surface 34) preferably includes a fill port 38 and air relief port 39, which ports can be separate from each other or combined together. The fill port 38 allows for filling of the firefighting fluid W into the reservoir 30. The air relief port 39 allows for air to pass into the reservoir as firefighting fluid W is pumped out of the reservoir 30 during use (or to balance pressure during circulation between units of the system 10, such as along interconnection conduits 140 (FIG. 1).

The cabinet 40 is on a front of the unit opposite the rear 33 and in one embodiment is located over the sump 35 of the reservoir 30 but otherwise at a similar level to most of a volume of the reservoir 30 on a forward side of the reservoir 30. The cabinet 40 includes a rear wall 41 acting as a dividing vertical (or near-vertical) wall between the cabinet 40 and the reservoir 30. A main shelf 42 defines a lower surface of the cabinet 40 which overlies the sump 35. The cabinet 40 can include one or more upper shelves 44 which can support various different items of equipment associated with the system 10 of this invention. A door preferably closes at least a majority of (and optionally all of) the cabinet 40 on a side of the cabinet 40 opposite the rear wall 41. The cabinet 40 can include side walls generally incorporated into the lateral sides 32 of the reservoir 30 so that the cabinet 40 has an integrated appearance with the reservoir 30 and base 20. The door can be closed to protect items within the cabinet 40, but as an option can include sufficient air gaps to allow for combustion air and general circulation within the cabinet 40, as one option. As an alternative, such circulation can be engineered into the cabinet 40 but in a manner other than passing through or around the door.

The main pump 50 is provided for delivery of firefighting fluid W from the system 10, generally as a high-pressure spray through a hose 58, typically exiting at a nozzle 59 of the hose 58 handled by firefighting personnel P (FIG. 1). This main pump 50 in one embodiment rests upon the main shelf 42 within the cabinet 40. The main pump 50 includes a body 52 which supports an impeller therein which increases a pressure of the firefighting fluid W passing through the body 52 of the main pump 50. An inlet pipe 54 is coupled to the body 52 and passes down into the reservoir 30 for intake of firefighting fluid W into the main pump 50. As one option, this inlet pipe 54 extends through the main shelf 42 of the cabinet 40 and down into the sump 35, typically extending near a lower surface of the sump 35 to allow for suction removal of substantially all of the firefighting fluid W from the sump 35 of the reservoir 30 by the main pump 50. This inlet pipe 54 can, as one option, be joined to the three way valve associated with the drain 26.

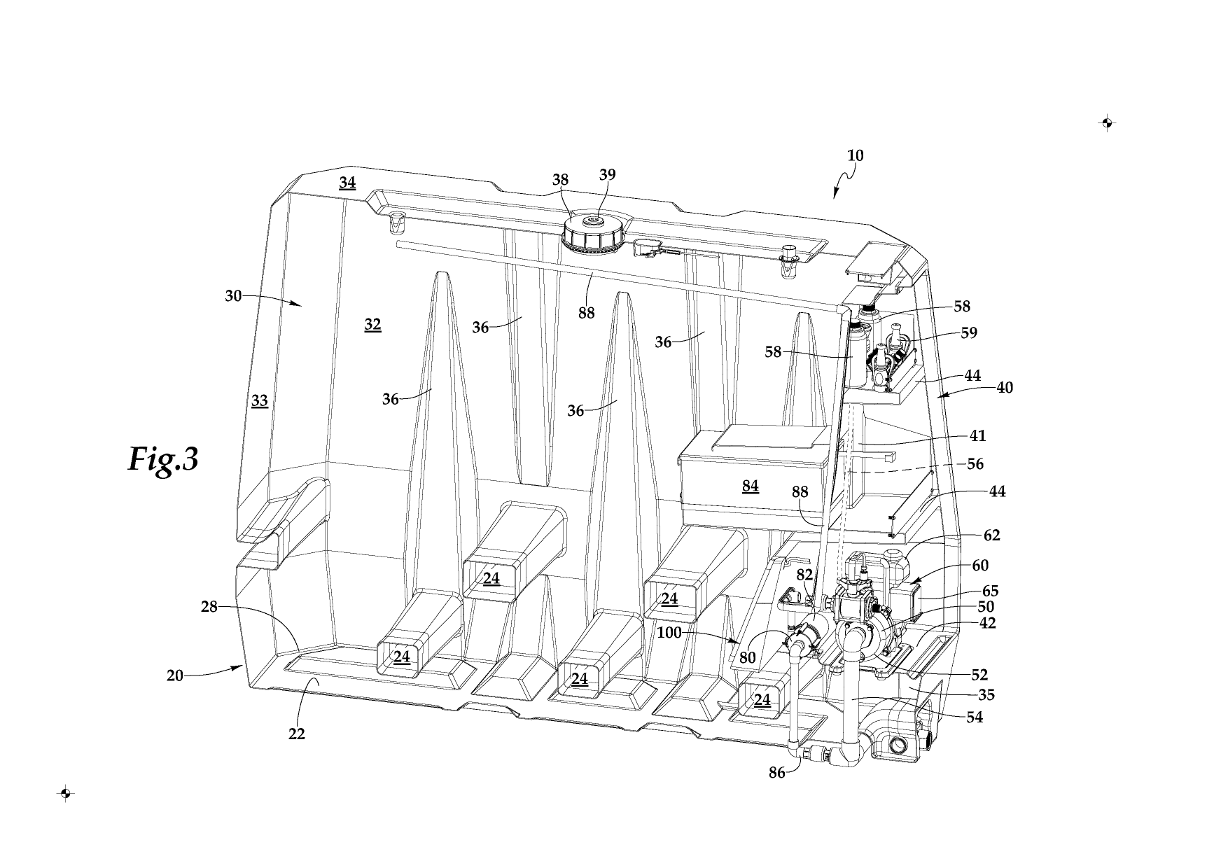

An outlet port 56 is also provided coupled to the body 52 of the main pump 50. This outlet port 56 typically extends up to upper portions of the cabinet 40 (FIG. 3) and can have one or more hoses 58 attached thereto. A control valve can also be associated with the main pump 50 to allow for control of flow of firefighting fluid W passing into and/or out of the main pump 50. The main pump 50 can be powered through an impeller which, as an option, can be activated and deactivated either in a manner controlled along with the control valve or in a manner with more passive control, such as with the impeller being disengaged when the control valve is closed either through appropriate sensors and signals and actuators, or in a passive manner, such as the impeller stalling out and stopping turning whenever flow into and/or out of the body 52 of the main pump 50 is impeded in some fashion (such as a valve on the hose 58 nozzle 59 being closed).

A motor 60 is coupled to the main pump 50, typically by being mounted directly to the body 52 of the main pump 50 with a rotating power output coupled to an impeller of the main pump 50, and also resting upon the main shelf 42 in the cabinet 40. This motor 60 could be an electric motor or a fuel combustion motor, with a fuel combustion style motor 60 primarily depicted in the figures herein. This fuel combustion motor 60 includes a fuel tank 62 associated therewith for storage of an appropriate amount of fuel, which can be combusted when operating the motor 60. This fuel tank 62 supports an appropriate fuel for the design of the motor 60, with such fuel optionally being diesel, gasoline, propane, kerosene, liquefied petroleum gas, or any other gaseous or liquid combustion fuel.

The motor 60 typically also includes general equipment associated with such fuel combustion motors, such as a carburetor or other air intake and fuel and air mixing, combustion chambers, cooling systems, valve systems, timing systems, etc. A starter 64 is typically also associated with the motor 60, as well as a starter battery 65 to allow for initiation of operation of the motor 60 desired. In one embodiment, the main shelf 42 of the cabinet 40 is sized so that the main pump 50 and motor 60 can rest adjacent to each other upon this main shelf 42. The main pump 50 and water 60 can be at least somewhat incorporated together as one option.

An exhaust subsystem 70 is also associated with the motor 60. This exhaust subsystem 70 is typically located at least partially within the cabinet 40 where it interfaces with the motor 60. Typically an exhaust manifold leads from the motor 60 and feeds into the exhaust subsystem 70. The exhaust subsystem 70 can include a muffler for muffling sound, a spark arrestor for preventing sparks from leaving the exhaust, and thermal insulation/management to ensure that no portion of the exhaust system is sufficiently hot to melt or otherwise damage materials forming the reservoir 30, base 20 or other associated equipment with the system 10.

In one embodiment, the exhaust subsystem 70 also feeds the exhaust away from the unit and sufficiently far from the motor 60 to ensure that products of combustion are not sucked back into an air intake of the motor 60 to potentially starve the motor 60 of fuel. Options for final exhaust of combustion gases from the exhaust subsystem 70 can include appropriate channels beneath the under surface 22 of the base 20 or out of an exhaust stack extending up above the top surface 34 of the reservoir 30, or out past a rear 33 of the reservoir 30, or out past one of the lateral sides 32 of the reservoir 30.

A recirculation subsystem 80 is preferably provided as part of the system 10 to ensure that the firefighting fluid W remains properly conditioned so that it is ready for optimal performance when needed. If the firefighting fluid W is already stable, such as if it is water, no such recirculation subsystem 80 would be needed. However, many firefighting fluids W will degrade in performance over time such as due to stratification/separation or deactivation or other decomposition. Depending on the type of firefighting fluid W, “retardant health” can be maintained with appropriate equipment. A basic recirculation subsystem 80 can keep the firefighting fluid W in a homogenous state which is sufficient to maintain retardant health for many firefighting fluids W.

Such a recirculation subsystem 80 would generally include a recirculating pump 82 which would be powered by electricity. As one option, an electric power cord 86 can power this pump 82. Alternatively, a battery 84 can be provided to deliver power to the recirculating pump 82. The battery 84 itself can be recharged in a variety of different ways, typically through a charging/power cord 86 routed from the cabinet 40 of the unit to a source of power. As one option, the source of power could be a solar panel or could be some available electrical outlet into which the power cord can be plugged. As one option, the battery 64 could be periodically recharged by an alternator powered from the starter 64 or starter battery 65 or powered by the motor 60. The motor 60 typically will periodically start to keep lubrication fluid circulating therein and to ensure a full state of readiness for the overall system 10. During such periodic operating cycles of the motor 60, such an auxiliary charger driven by the motor 60 could deliver electric power to the battery 84 to top off the battery 84 and ensure that it is ready to operate as part of the recirculation subsystem 80.

The recirculation subsystem 80 would also include input/output lines 88, which would be spaced from each other on the reservoir 30 to ensure that a full volume of the reservoir 30 is routed through the recirculating pump 82 for recirculating and remixing thereof. A timer or other control system can be associated with the recirculating pump 82 to cause it to operate periodically and ensure maintenance of retardant health of the firefighting fluid W within the reservoir 30. Typically, the recirculating pump 82 and associated battery 84 would be located upon one of the upper shelves 44 in the cabinet 40. Alternatively, this recirculating pump 82 could be located within the reservoir 30 itself or otherwise located adjacent to and as part of the system 10. Optionally, the recirculating pump 82 and other parts of the recirculation subsystem 80 could also feed interconnection conduits 140 to flow firefighting fluid W between multiple units of the system 10 (FIG. 1).

A telemetry/control subsystem 90 is also preferably provided as a portion of the system 10. This telemetry/control subsystem 90 includes an antenna 92 and control signal wiring 94 leading from the antenna 92 and through an appropriate microprocessor/CPU 95 (such as including memory, a computer, or other electronics), and to each of the items of equipment to be controlled by the telemetry/control subsystems 90. Also, sensors 96 of various types can have control signal wiring 94 leading from the sensors 96 to the processor/CPU 95 within the telemetry/control subsystem 90.

One purpose of the control subsystem is to communicate status of the system 10 to interested personnel who may be present adjacent to the system 10 or located remotely. The telemetry/control subsystem 90 can facilitate communication appropriate for the circumstances. If interested users or other personnel are close by, a 900 MHz or other relatively short range communications antenna 92 can be utilized. If a greater distance is involved, the antenna 92 could be in the form of a satellite dish, such as a Starlink satellite dish, for uploading and downloading information to and from the system 10 with the Internet and authorized personnel accessing this information through the Internet or some other wide area network or local area network.

Remote monitoring/control 98 could be in the form of a smart phone, a personal computer, or some purpose belt controller type device, such as a remote control for the system 10. Examples of controls, which can be operated by a user include activation of the main pump 50, starting of the motor 60, activation of the recirculation subsystem 80, opening of valves, such as associated with the hose 58 and/or sprinklers 120, or monitoring various parameters and conditions associated with the system 10. Sensors 96 can assess such conditions which can include temperature of the firefighting fluid W, ambient temperature, humidity, state of operation of various different items of equipment associated with the system 10, and potentially other sensors as well.

Other sensors 96 to optionally include in the system 10 include:
1. A pH sensor to measure acidity/alkalinity of the fire retardant solution. This helps to ensure the retardant remains within the target chemical range (typically ≈ 4.5–6.0); detects contamination, degradation, or improper dilution; and supports long-term stability monitoring.
2. A conductivity sensor to measure electrical conductivity of the solution, which correlates with dissolved salts (e.g., magnesium chloride concentration). This helps to detect dilution with water, confirms concentration consistency, and identifies contamination or formulation drift.
3. A turbidity sensor to measure optical clarity / suspended particle content. This helps to detect settling or phase separation, identifies contamination or debris, and monitors suspension stability of lignosulfonate and polymers.
4. An oxidation-reduction potential (ORP) sensor measures oxidation state of the solution. This is useful if preservatives or reactive additives are introduced, and indicates chemical aging or breakdown.
5. A fluid temperature sensor, not only to prevent freezing conditions when activating the heating pad 100, but also tracks viscosity changes due to temperature, and can help to protect chemical stability.
6. An ambient temperature sensor to measures external air temperature around the unit. This can help to predict freeze risk, supports automated heating or recirculation logic, and enable environmental condition tracking.
7. A tank level sensor (float, radar or ultrasonic). This can help to confirm system readiness, prevent dry pump operation, enable refill alerts and provide inventory tracking for “fleets” of systems 10.
8. A density/specific gravity sensor. This can help to detect dilution or concentration changes and verify batch consistency of the firefighting fluid.
9. Bottom-mounted tank pressure sensor (hydrostatic level measurement). This measures the hydrostatic pressure at or near the bottom of the storage tank to determine the height and volume of the fire retardant fluid. This can be used as a form of verification for other sensors 95 of the system 10.
10. A flow meter to measure volumetric flow rate of the retardant. This helps to confirm fluid movement, verify system discharge performance, and support calibration of application rates.
11. A pressure sensor to measure pressure in the output of the pump 50 and elsewhere in the system 10. This helps to detect clogging or restrictions, identify increased viscosity or thickening, and monitor pump performance.
12. A pump speed/motor sensor to monitor pump RPM or motor load. This helps to detect pump wear or failure, and correlates flow and pressure performance.
13. Leak detection sensors to detect presence of liquid in unintended areas (container 30 exterior, inside cabinet 40, or adjacent regions). This helps to prevent environmental damage, protects equipment, and quickly alerts operators to failures.
14. Valve position sensors to detect whether valves are open or closed. This helps to ensure correct system configuration and prevents accidental discharge failure.
15. A cabinet 40 temperature sensor to monitor internal control box temperature. This helps to protect electronics from overheating or freezing and helps to ensure system reliability.
16. A viscosity monitoring sensor (direct or inferred) to measure or infer firefighting fluid W viscosity. This helps to determine pumpability, detects polymer degradation or thickening, and indicates freeze or aging effects. Such sensors/readings are often inferred using: pressure, flow and/or temperature relationships.
17. Optical/imaging sensors for visual monitoring of fluid condition or discharge patterns. This helps to detects abnormal behavior and enables AI-based diagnostics.

All sensors may be connected to the CPU 95 or other controller (PLC or embedded system). These sensors can access various types of wireless communication modules (WiFi, cellular, satellite), such as through the antenna 92, and can feed relevant data to a remote monitoring dashboard. Such sensors 96 can facilitate real-time monitoring, automated alerts, predictive maintenance and data logging for insurance, compliance and other purposes.

In one embodiment, heating pads 100 or other heating system are located within the reservoir 30 or otherwise adjacent to the fluid F. The heating pads 100 serve the general purpose of keeping the firefighting fluid W from freezing if excessive cold temperatures are encountered. As one option, the heating pads can be powered by the battery 84 of the recirculation subsystem 80, or the battery 84 of the recirculation subsystem 80 can be a shared battery along with a specific battery for powering of the heating pads 100. The heating pads 100 can be thermostatically controlled, such as to keep the firefighting fluid W from dropping below 40°, as one option. For certain climates, the reservoir 30 can be insulated to some extent to minimize a need for the heating pads 100 and/or to minimize cycling of the heating pad 100 system. Alternative heating systems to the pads 100 could include heating elements on fluid F piping of the system 10.

The system 10 can be configured to scale with multiple units (also called auxiliary units or auxiliary reservoirs) in a variety of different ways. As a simplest methodology of expanding the system 10, two or more units can merely be placed adjacent to each other and be identical in form and merely be accessed by the same firefighting personnel P in a sequential manner as needed (FIG. 1). A first unit would first be utilized by firefighting personnel P until the reservoir 30 is depleted of firefighting fluid W. Then the second unit could be activated by the firefighting personnel P to continue fighting the fire. As an alternative, interconnection conduits 140 can extend between adjacent units. As an option, when such interconnection conduits 140 are utilized, expansion units of the system 10 can be provided which do not include the main pump 50, motor 60, exhaust subsystem 70 or even the recirculation subsystem 80, but rather rely upon such equipment from an adjacent unit. If required, a fluid exchange pump can be provided to pump fluids between reservoirs 30 of separate units. Typically, each such unit, even if only including a reservoir 30 and without associated equipment, would typically also at least include the heating pads 100. Electrical connection between multiple units can occur to supply electric power to such heating pads 100 of each of the reservoirs 30.

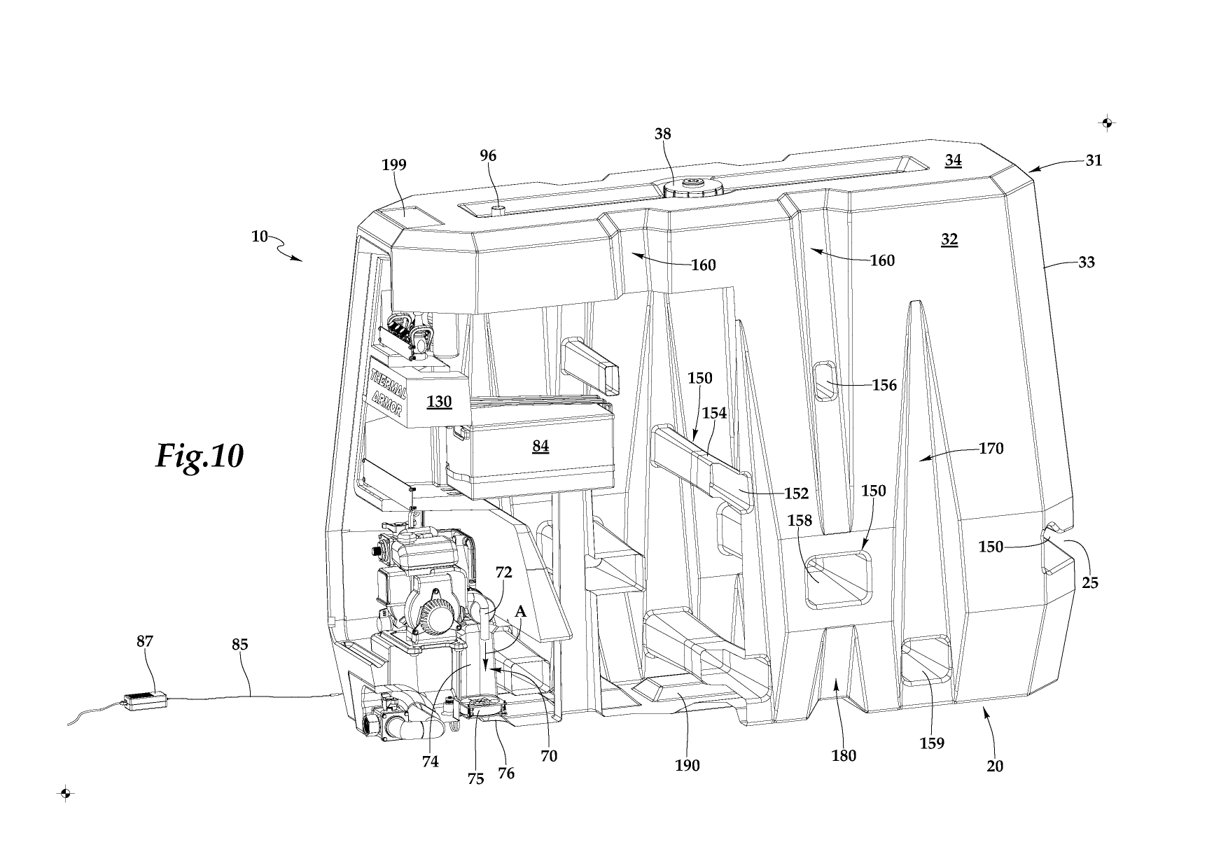

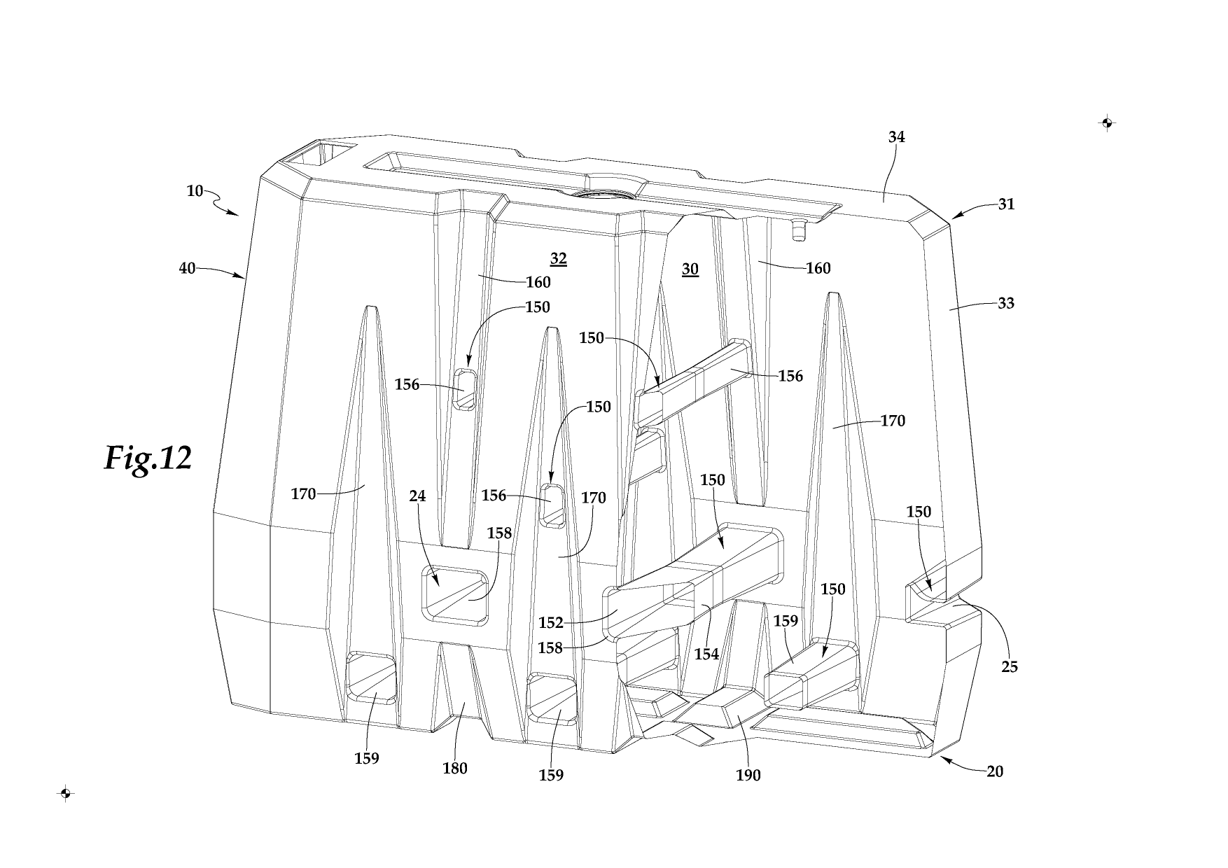

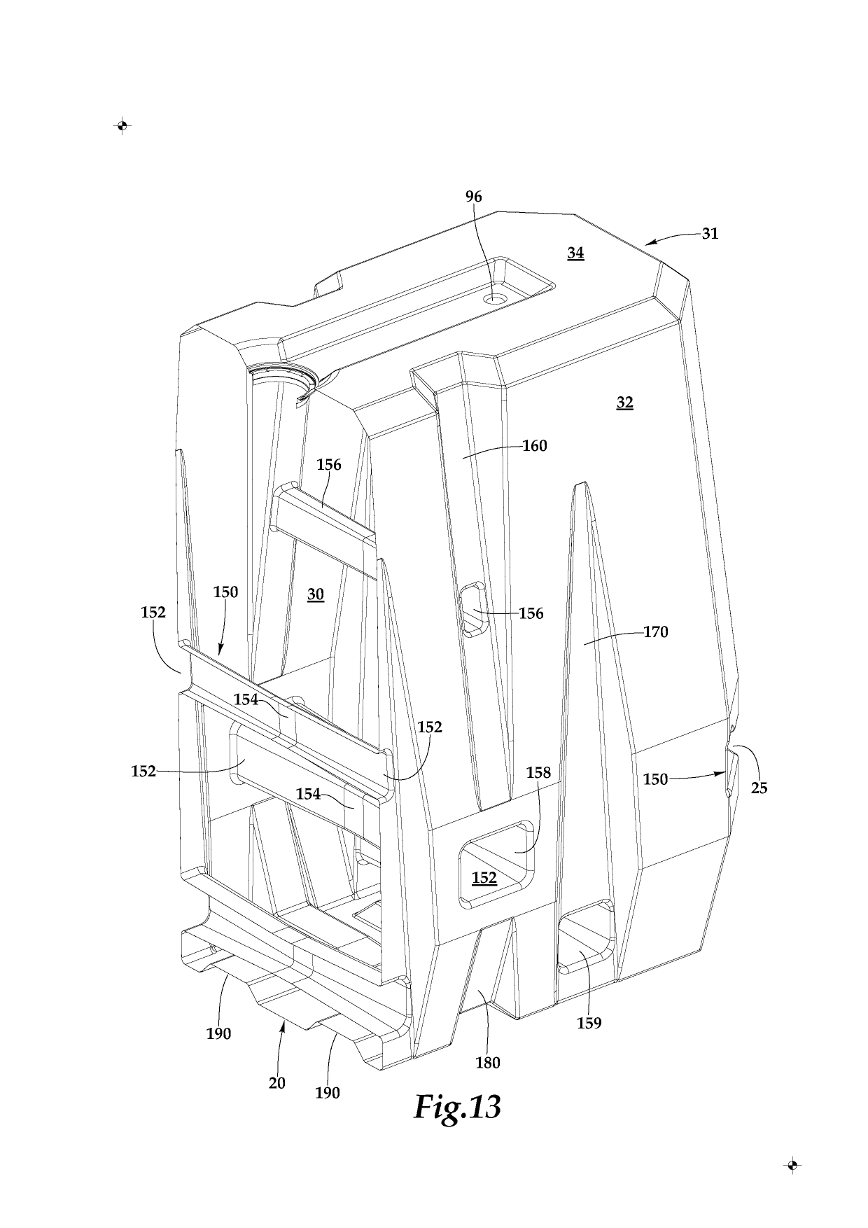

With particular reference to FIGS. 10-13, further details of the system 10 of this invention are described, according to various example embodiments. Various details shown herein can be combined together in some embodiments or left out in some embodiments, or substituted for other details. Details such as signal carrying wires are largely omitted to allow for functional components of these embodiments to be more clearly seen.

An enclosure 31 is provided in one embodiment as a unitary mass of monolithic material which comprises the base 20, reservoir 30 and at least a general outline of the cabinet 40. This enclosure 31, as shown in FIGS. 10-13, is particularly configured to be optimized for manufacturer by roto-molding. For instance, a plurality of stiffeners 150 are provided as portions of this enclosure 31. These stiffeners 150 pass between the lateral sides 32 of the enclosure 31 passing through the reservoir 30.

While these stiffeners 150 decrease slightly a volume of the reservoir 30, they provide at least three specific benefits. First, the stiffeners 150 helped to keep the lateral sides 32 from moving relative to each other, such as away from each other, as can otherwise occur when the reservoir 30 is filled with firefighting fluid W. This also allows a thickness of the walls of the enclosure 31 to be optimized and generally reduced, and still maintain its shape under various loads, including the hydrostatic loads associated with filling the reservoir 30.

Second, these stiffeners 150 double as lift tubes, which can have straps, ropes, or other lines passing therethrough (or into which some form of anchor can be secured) and then used to lift the entire enclosure 30 and move it as desired. For instance, some form of lift device can conveniently move the entire enclosure 31, even if already filled, through utilizing appropriate straps passing through (or at least to) these stiffeners 150.

Third, these stiffeners 150 (at least lower tubes 159 and mid tubes 158) are sized and shaped to allow tines of a forklift to fit therein, and to allow for forklift movement of the entire enclosure 31. Upper tubes 156 could conceivably also be engaged by forklift tines of an appropriate shape (or other lift equipment), as an option. Furthermore, the handle 25 in the rear 33 can also act as a form of stiffener 150 and also as a form of lifting structure, which can be engaged by straps, lifting machinery, such as forklifts, or merely by hands of a user (or group of users), to position the enclosure 31 where desired.

The enclosure 31 also includes a variety of facets 160, 170, 180 to further assist in stiffening the enclosure 31 to both preserve shape of the enclosure 31 and allow for minimization of wall thickness of the enclosure 31. Furthermore, these facets 160, 170, 180 can provide a unique appearance which can be helpful in allowing firefighting personnel to remember, recognize, and be more likely to utilize the system 10 included within the enclosure 31. Such unique appearance could be further augmented with paint schemes, wraps, stickers, or other external ornamentation. Alternatively, camouflage could be placed on the surface should it be of highest priority to minimize a degree to which the enclosure 31 can be seen (especially when not in use).

These various facets include upper facets 160, large lower facets 170, small lower facets 180 and floor ribbing 190, which all help to enhance stiffness of the enclosure 31. The upper facets 160 generally extend from the top surface 34 down toward the under surface 22 of the base 20. Most typically, these upper facets 160 stop short of the under surface 22, and in the embodiment shown extend slightly past a mid height point on the enclosure 31. However, various different lengths of the upper facets 160 could be provided. These upper facets 160 extend generally vertically and have a main central surface, which is generally rectangular and two side surfaces, which are generally triangular, imparting the shape that is shown. Upper tubes 156 are located within each of these upper facets 160 (in the example embodiment shown) and the upper facets 160 and upper tubes 156 cooperate to some extent to enhance stiffness of the overall enclosure 31.

Large lower facets 170 extend up from the under surface 22 of the base 20 toward the top surface 34. These lower large facets 170 similarly include a central main surface, which is close to rectangular but tapers slightly as it extends up from the under surface 22, as well as two side surfaces, which are generally trapezoidal in form. The lower tubes 159 are preferably located within each of the large lower facets 170 and to some extent cooperate with the large lower facets 170 to enhance stiffness of the enclosure 31.

Small lower facets 180 are preferably also provided beneath each of the upper facets 160 and extending up from the under surface 22 of the base 20. These small lower facets 180 are shown in this embodiment with a generally rectangular center surface and a pair of triangular side surfaces. Floor ribbing 190 interrupts what would otherwise be a planar under surface 22. The floor ribbing 190 helps to stiffen the overall enclosure 31 by avoiding large planar surfaces, which would otherwise be prone to bending and other distortion.

Overall, the enclosure 31 including these various facets 160, 170, 180 and floor ribbing 190 have a character which avoids large flat planar surfaces making up significant portions of the enclosure 31 Large flat surfaces can be prone to bending when encountering different loads, including hoop stress type bulging loads associated with hydrostatic pressure, when the reservoir 30 is filled at least partially with firefighting fluid W.

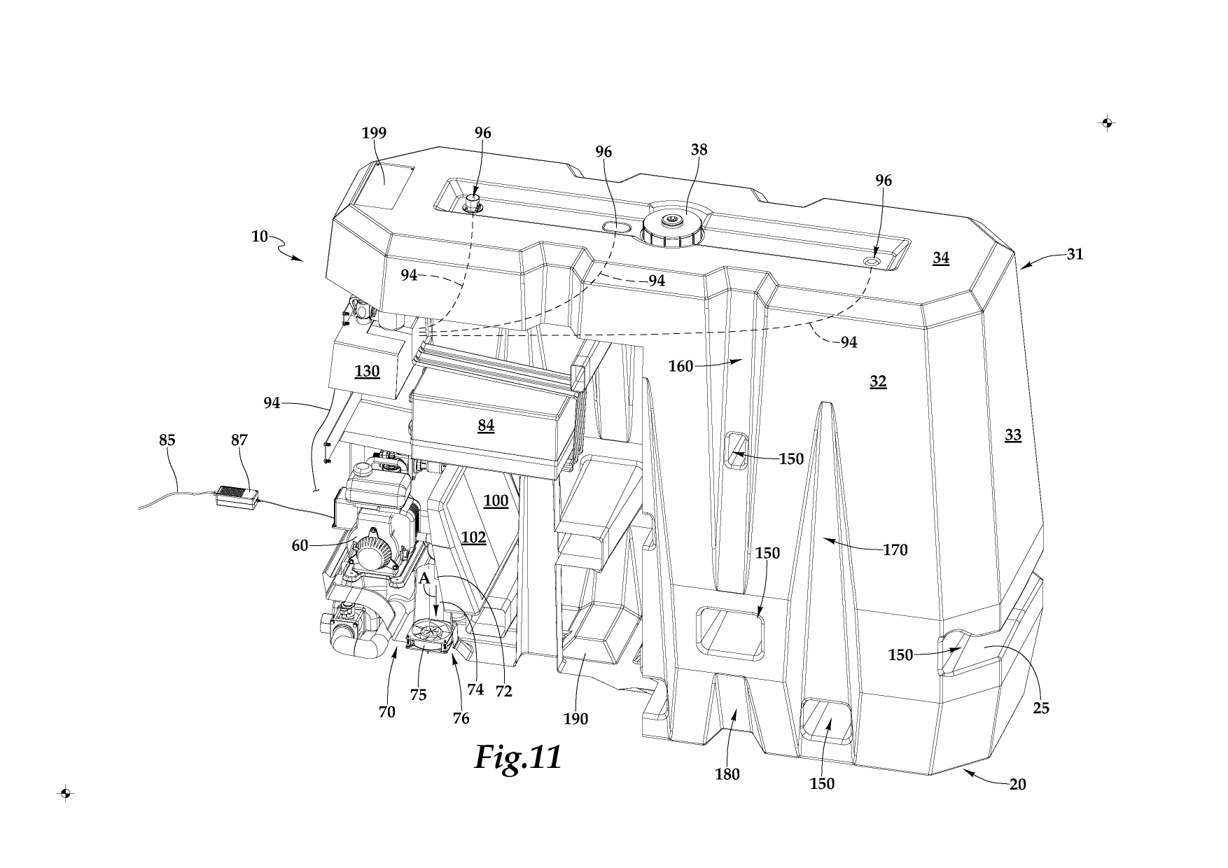

With reference to FIGS. 10 and 11, further details of the exhaust subsystem 70 are described according to one example embodiment. In this embodiment, an exhaust pipe 72 leads away from the motor 60 (which would be in the form of a fuel combustion motor). This exhaust pipe 72 feeds into a pathway 74, which in the example embodiment shown, extends downwardly and passes through the under surface 22. The pathway 74 thus acts as a tunnel, extending from the cabinet 40 down through the under surface 22. To the extent the cabinet 40 includes a main shelf 42, this pathway 74 passes through this main shelf 42 on a rearward portion of the cabinet 40, spaced from the entry into the cabinet 40, which would be selectively closable with a door.

The pathway 74 includes an exhaust fan 75. The pathway 74 interfaces with the under surface 22 at a floor exit 76. In one embodiment, the exhaust fan 75 is adjacent to this floor exit 76, but could alternatively be located elsewhere within the pathway 74. The exhaust fan 75 is oriented to drive exhaust gas from the exhaust pipe 72 down through the floor exit 76 (along arrow A of FIGS. 10 and 11) and out of the cabinet 40 as well as out of the enclosure 31 beneath the under surface 22 and beneath the base 20. Because the under surface 22 includes the floor ribbing 190 therein, various channels between the floor ribbing 190 are available for passage of these exhaust gases and dissipation into a surrounding environment. If desired, this floor ribbing 190 or an extending portion of the pathway 74 could extend horizontally adjacent to the under surface 22 and lead these exhaust gases to a desired exhaust point, such as further away from the cabinet 40 (such as adjacent to the rear 33 of the enclosure 31).

Preferably, the exhaust fan 75 not only draws exhaust from the exhaust pipe 72 of the motor 60 out of the cabinet 40, but also draws ambient air out of the cabinet 40 when desired, promoting circulation within the cabinet 40. Exhaust fan 75 provides a variety of benefits for the cabinet 40. Fan 75 operation draws fresh air into the cabinet 40 and prevents the cabinet 40 from attaining a temperature therein which is above ambient temperature outside of the cabinet 40 and outside of the enclosure 31 (or only a small amount, hotter than ambient temperature). This can be beneficial for sensitive electronics, which can be contained within the cabinet 40 and rely at least somewhat on the exhaust fan 75 to maintain operating temperature within design parameters.

The door enclosing a front portion of the cabinet 40 would typically have vents therein or be designed to not seal tightly at a perimeter thereof to allow for fresh air to pass through or around the door and into the cabinet 40, and then be exhausted from the cabinet 40 by the exhaust fan 75. Other forms of inflow ventilation into the cabinet 40 could alternatively be provided, such as vents designed for that purpose in sides of the cabinet 40, which are defined by portions of the enclosure 31 opposite the rear 33. Such vents can be configured to keep insects, rodents, or other pests from passing into the cabinet 40, but to preserve ability for ventilating air to pass into the cabinet 40. The exhaust fan 75 is preferably similarly sized and shaped along with the pathway 74 to close off access for pests into the cabinet through this pathway 74.

With further reference to FIGS. 10 and 11, further details of the recirculation subsystem 80 and telemetry/control subsystem 90 and associated components and accessories are described, according to a various example embodiments. The recirculation pump 82 of the recirculation subsystem 80 can be powered in a variety of different ways. In one simple embodiment, a power cable 85 merely extends from the recirculation pump 82 to an external source of power, such as power available on an exterior of a residence or other structure. Typically a transformer/rectifier 87 would be provided to convert power from such a source to DC electricity to power the recirculation pump 82 (provided it uses a DC motor). Alternatively, only a transformer 87 without rectifying would be suitable if the recirculation pump 82 were driven by an AC motor.

As an alternative, a battery 84 can be provided within the cabinet 40 (or a horizontal extension, extending out of a rear side of the cabinet 40), or otherwise located within the cabinet 40 or elsewhere within the enclosure 31. If such a battery 84 is provided, it would typically directly power the recirculation pump 82 (with an inverter if needed). The battery 84 would in such an embodiment utilize the power cord 85 and associated transformers/rectifier 87 for recharging of the battery 84. Other recharge sources could include solar panels and/or an electric generator powered by or incorporated into the motor 60. If recirculation pump 82 primarily or entirely relies upon a source of power other than the battery 84, the battery 84 could be resized to merely provide power for other accessories, such as the exhaust fan 75, heating subsystem 100 and various electronics powering controls and sensors associated with the system 10 of this invention. Alternatively, the battery 84 could merely be large and provide an exceptionally high degree of reliability to the system 10.

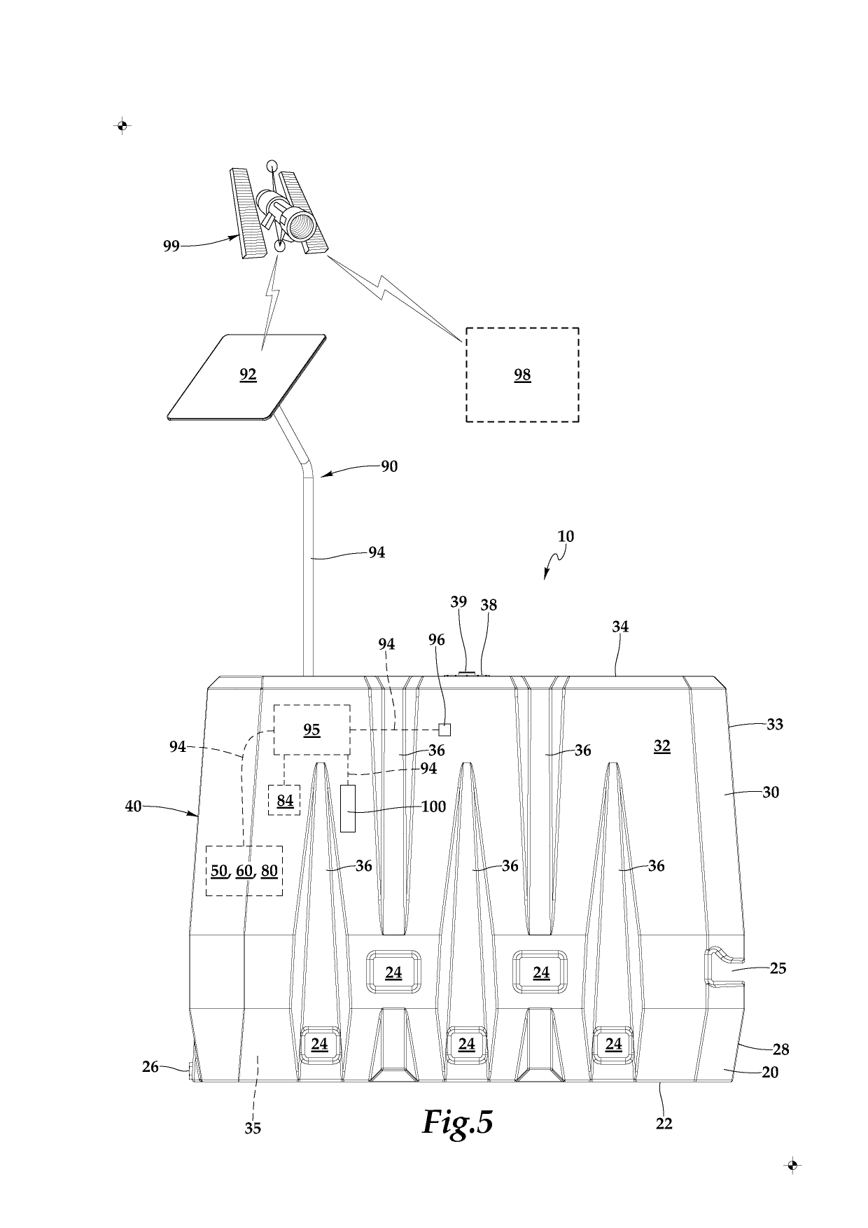

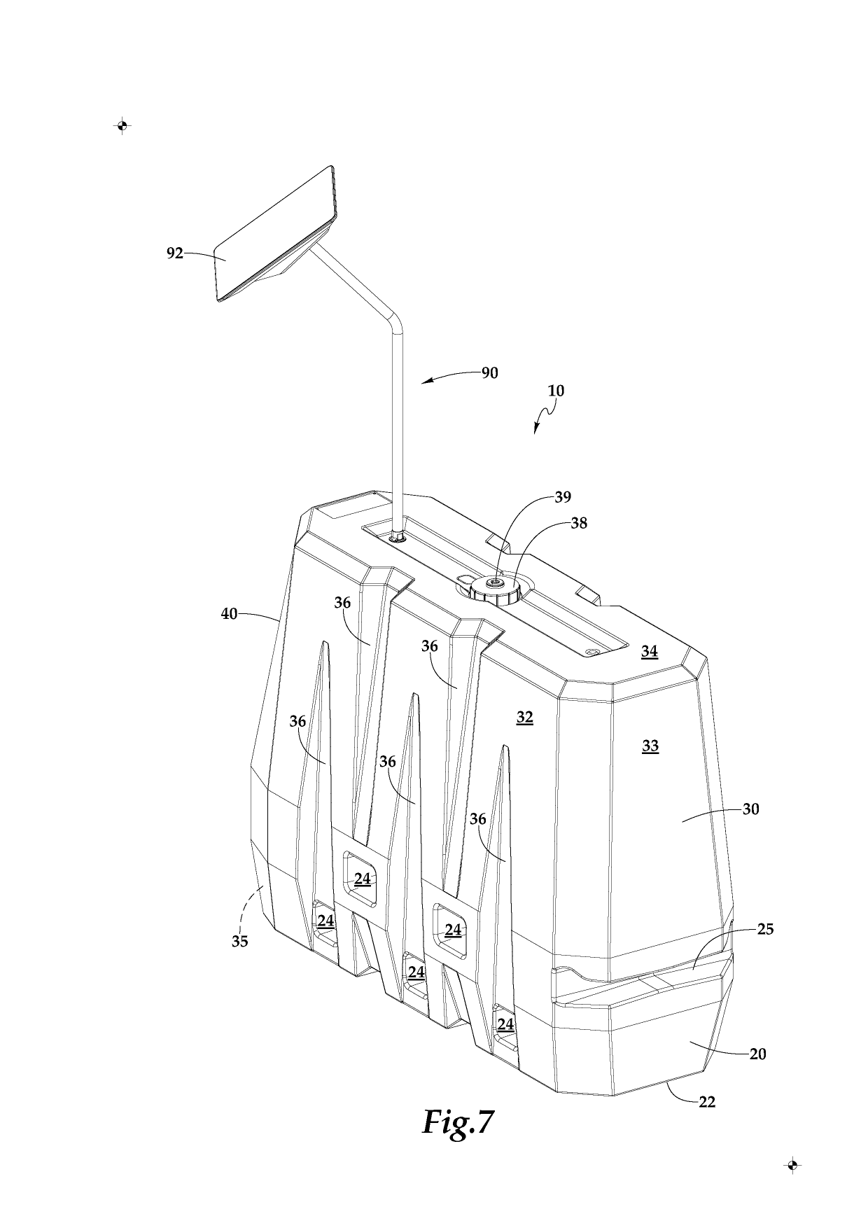

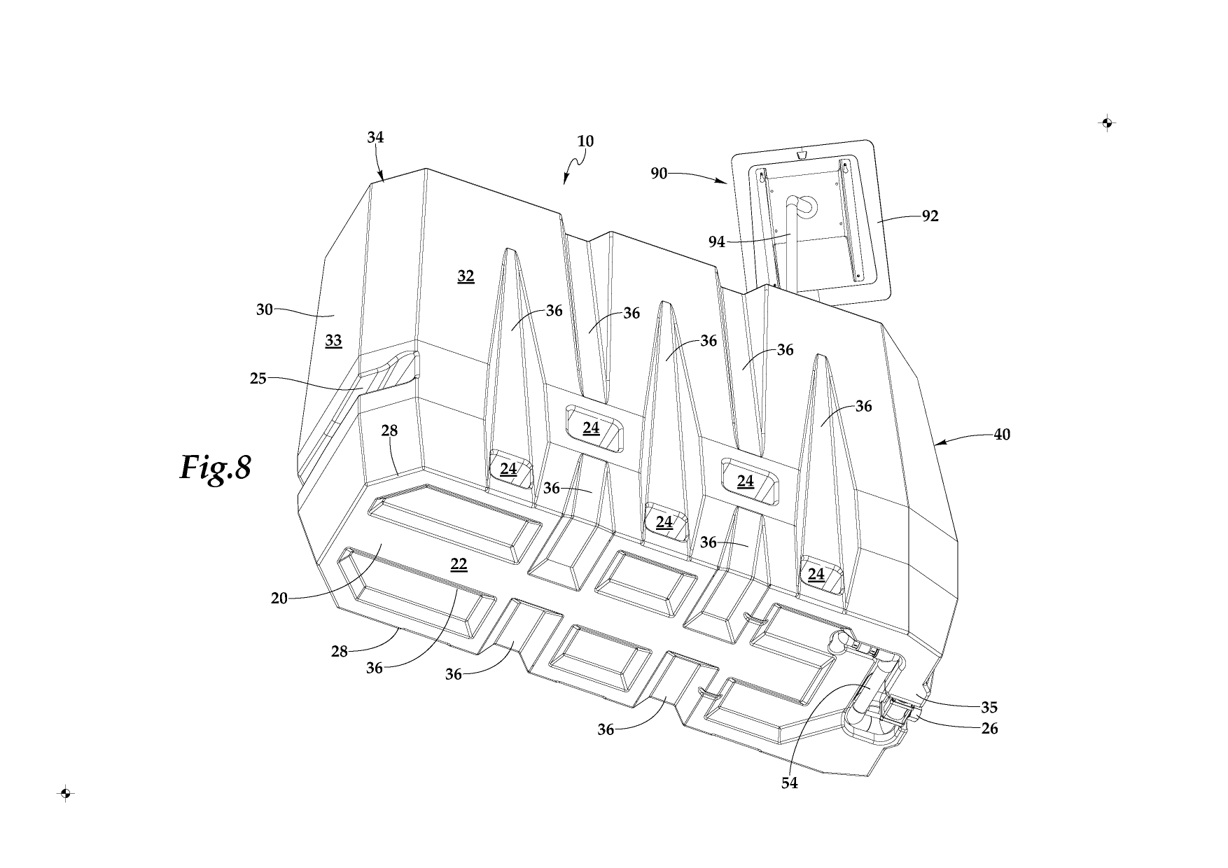

For convenience, FIGS. 10 and 11 have had the antenna 92 of the telemetry/control subsystem 90 (see FIGS. 5, 7 and 8) left out. Furthermore, control system wiring 94 has been shown in FIG. 11, but omitted from FIG. 10, 12 and 13. It would be expected that every component within the system 10 would have at least one wire connected thereto, which wires have been omitted to avoid obscuring the components themselves. The wiring would come in a variety of sizes and styles and serve various purposes. In particular, some wires would be electric power wiring to supply electric power to various components that require power (or supply power to other components). Other wiring would be in the form of control signal wiring, which would deliver control signals between components or between the CPU 95 (FIG. 5), and various other components. Other wires will be in the form of sensor wires, which would typically run from one of the sensors 96 to the CPU 95. In the embodiment depicted in FIGS. 10 and 11, a CPU enclosure 130 is provided within the cabinet to contain the CPU 95 and other processor electronics. At least some of this wiring could be replaced with wireless communications, such as utilizing the Bluetooth protocol or other radio frequency signaling.

The various sensors 96 can be in the form of any one of the sensors listed above. While the sensors 96 would generally communicate with the CPU 95 within the CPU enclosure 130, it is conceivable that some subsystems could have their own thermostatic controls or other control subroutines which do not rely on the CPU 95. For instance, the heating subsystem 100 could include heating pads 102 which are merely thermostatically controlled by connecting the heating pads 102 to a source of power such as the battery 84 through a switch that is open or closed based on a temperature reading of a temperature sensor 96 within the reservoir 30.

The sensors 96 will be located on an exterior of the enclosure 31 or an interior of the enclosure 31 or located elsewhere within the system 10 based on the type of sensor that is involved, and to provide for a most accurate sensor 96 reading. Alternatively, to at least some extent the sensor 96 could be located less optimally for convenience, provided that sensor readings are not distorted beyond an amount that can be either accepted through calibration or accepted as within a margin of error for the sensor 96 and control systems utilizing the sensors 96.

Examples of control systems implemented by the system 10 of this invention can include, as an example automated controls, which take at least some actions without human intervention and active controls, which take at least some actions based on initiation by a user. The user could be adjacent to one of the units of the system 10, but would most typically have a computer or other smart device 98 at some remote location and utilize signals transmitted by the antenna 92 (or other signal carrying pathways, such as through a satellite 99, as one option) to communicate with the system 10.

Automated controls could include a control system which turns on the strobe light 199 when certain conditions exist. For instance, if any portion of the system 10 is in an active state, such as the motor 90 is operational and the main pump 50 has been activated to supply pressurized firefighting fluid W to an outlet port 56, these strobe light 199 can be automatically illuminated. Such illumination can provide important information to firefighting personnel, such as that the system 10 is operational and available for use. The strobe light 199 can have various different colors to allow for quickly discerning the state of the system, such as yellow lights indicating that the reservoir is approaching an empty state, or green indicating that the reservoir 30 is empty and needs to be refilled. Other coloring schemes could alternatively be utilized, depending on the expectations of firefighting personnel and other users. In addition to or as an alternative to the strobe light 199, some form of audible alarm could be provided, such as to allow firefighting personnel P to quickly find the unit of the system 10, even in heavy smoke or other low light conditions, or should the unit become at least somewhat hidden by vegetation or other impediments.

Sensors 96 which can communicate system 10 readiness can include fluid level sensors 96, chemical condition sensors 96, environmental conditions sensors 96, and other ones of the system sensors 96 described above. The overall system can thus provide a distributed fire suppression system comprising a plurality of self-contained fire suppression units in a network as part of an emergency response system, where each unit communicates operational readiness and is selectively activated to coordinate fire mitigation across multiple locations.

Furthermore, the various sensors 96 associated which each system 10 can communicate environmental conditions to a command center fighting a fire event. For instance, sensors 96 such as temperature sensors, humidity sensors, and wind sensors, as well as other sensors 96 can provide information to decision makers, which can be useful in defense of structures and lives during a fire event, especially a wildfire event.

At least one of the sensors 96 can monitor state of charge of the battery 84 and details such as level of fuel within a fuel tank associated with the motor 60. The system 10 can respond to these capacity level sensors and manage operation of the system appropriately. For instance, if the fuel tank 62 is low on fuel, appropriate communications can be sent to maintenance personnel. Other details can be managed by memory associated with the CPU 95, which can keep track of details such as when the fuel within the fuel tank 92 was last refreshed, and when other maintenance has last been performed. When battery charge levels are getting too low, signals can be sent to initiate recharging of the battery or other servicing of the battery. Furthermore, most critical systems can be given priority, so that remaining charge within the battery can be most efficiently utilized, such as to favor operational control of the motor 60 and main pump 50 and other critical subsystems which facilitate active fighting of a fire event over ongoing monitoring, should battery power be limited.

The sensors 96 can also automatically (or through notification of a user) initiate operation of the system 10, such as by detecting heat, smoke or some other condition indicative that a fire event exists. The system 10 can then automatically respond, such as by supplying pressurized firefighting fluid W to sprinklers 120 or otherwise appropriately respond to defend structures or otherwise defend against the fire event. The system 10 can be configured to continue operation, even in the absence of communication through the telemetry subsystem 90. The system 10 can be programmed to have a default operational condition when communications are interrupted or disrupted, to allow for the system 10 to continue to operate in the absence of communication.

Sprinklers 120 (FIG. 1) and other outlets, such as water cannons, could be set up to operate autonomously and without requiring firefighting personnel P to be present and for the system 10 to still be activatable remotely. The control system would first utilize the starter battery 65 and starter 64 associated with the motor 60 to caused the motor 60 to begin running. The motor 60 would then energize the main pump 50 so that the main pump 50 is providing pressurized fluid to the outlet port 56. Appropriate valves could be in the form of control valves, which would then be appropriately opened to supply high pressure firefighting fluid W from the outlet port 56 to a pathway opened by the valves, to feed firefighting fluid W to the sprinklers 120 or to a water cannon or other unmanned outlet downstream of the outlet port 56.

Such controls can be integrated into an emergency response network, including official firefighting personnel who can remotely operate the system 10 both for autonomous operation and also to bring the system 10 online as a firefighting asset, and allow for coordination of the dispatching of firefighting personnel to the location of the system 10 for utilizing the system 10 in fighting a fire event. The telemetry/control subsystem 90 can be configured to communicate with an external emergency response system to provide operational status of the fire suppression system 10, and to also allow for control of the system 10. Furthermore, other non-emergency control can be provided, such as control of fire retardant health through operation of the recirculation subsystem 80, and generally monitoring sensor outputs to evaluate health of the overall system 10.

The system 10 can include a GPS or similar sensor 96 so that the system 10 can know its location. As an alternative, this location for the system 10 can merely be inputted into the CPU 95 or otherwise associated with signals which come from the system 10, such as through the telemetry 90 subsystem. In this way, multiple such systems 10 (and units with a system 10) at different locations can be placed on a map and visualized by an incident commander who is managing a fire event and allow for visualization of available resources and their current status.

The various different sensors and controls of this invention involve a processor and/or control system, which receives as input data from various different sensors and then outputs at least one operational function based on data received from at least one sensor. Examples of such operational functions include activation of the main pump 50, starting of the motor 60, activation of the recirculation subsystem 80, activation of the heating system 100 and/or heating pads 102, and opening/closing of various different valves such as those downstream of the main pump 50 and associated with the inlet pipe 55 and/or outlet port 56 and the drain 26, to facilitate control of fluid flows within the system 10. Other operational functions could also be provided by the system of this invention in various different embodiments.

The system 10 maintains a continuous operational readiness state by monitoring operational condition of at least some (and preferably all or nearly all) of the components and subsystems which comprise the system 10. When sensors 96 indicate that operational readiness of components and subsystems is adequate, the system is in an operational readiness state. When the sensors indicate inadequate conditions, appropriate maintenance/repair personnel are notified, such as utilizing the telemetry subsystem 90 to send a signal through email, text messaging, automated phone call, etc. to have appropriate service performed on the component(s) of the system 10 that requires maintenance and/or repair. In one embodiment, set points for what defines adequate conditions and inadequate conditions are selected so that even when the system 10 is notifying personnel of an inadequate condition, the system 10 is still in an operational readiness state, but needs service so that it can avoid falling further and becoming non-operational. For instance, while the fuel tank 62 is ideally entirely full, it can flag an inadequate condition when it drops below 95% full, and send an appropriate signal for topping off the fuel tank 62. However, the system 10 would still work adequately, but perhaps for a slightly lesser time duration, with an almost full fuel tank 62.

At least some of the maintenance/repair of the system 10 can occur in an automated fashion. For instance, the firefighting fluid W can be improved in health by operating the recirculation subsystem 80 periodically. Sensors 96 which detect reduced health of the firefighting fluid W can trigger operation of the recirculation subsystem 80. After such operation of the recirculation subsystem 80, the sensors 96 can again be queried, and if health of the firefighting fluid W is again within predefined ranges, the system 10 has effectively repaired an otherwise inadequate condition without requiring service personnel to visit the system 10.

Various different parameters can be monitored by the sensors 96, and when predefined acceptable ranges are exceeded or other thresholds are exceeded, alerts can be generated and sent as appropriate. In one embodiment, the system is not continuously doing self-diagnostics, but does them on a periodic schedule, which is selected based on experience of the user or other criteria. In one embodiment, servicing of the system 10 is performed based on signals received from the sensors 96. In other embodiments, the sensors 96 are used to predict when maintenance will be required. In other embodiments, the sensors 96 signal that maintenance is required when thresholds are exceeded. Maintenance can also (or alternatively) be based on a schedule with the units of the systems 10 being periodically visited and maintenance performed.

The system 10 can have various different operational states. In one operational state, the system 10 is entirely idle and conserving charge in the battery 84 and otherwise merely standing by. In such an idle state, it can still have its telemetry/control subsystem 90 powered just enough to receive signals that can “wake up” the system 10 to a more active operational state. A full “power off” option can also be provided for the system 10, such as when the system 10 is in storage or desired to be taken entirely off-line. More active operational states can be maintained by the system 10, such as where the firefighting fluid W is being monitored and its health maintained, which would be useful whenever the system 10 is filled with firefighting fluid W. Other operational states for the system 10 can be monitoring states where the system is merely monitoring its sensors and passing them through the telemetry subsystem 92 command-and-control systems and personnel, and an active event state where the system 10 is in a most active state, ready to be used (or actually being used) in defense against a fire event.

The system 10 can monitor how full the reservoir 30 is and can optimize usage of the firefighting fluid W based on available volume. For instance, as the reservoir 30 reaches the state where it is less than half full, a flow rate of firefighting fluid W leaving the main pump 50 can be throttled to a lower flow rate so that discharge of firefighting fluid W can last for a longer period of time (even though at a lower flow rate). Other adaptations of the system 10 based on available volume of firefighting fluid W could include prioritizing valves which feed a hose 58 used by personnel P over automated fluid W discharge systems, such as sprinklers 120.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this

invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A fire suppression system comprising:
a reservoir containing firefighting fluid;
a pump configured to discharge the fluid;
at least one sensor configured to monitor a system condition;
a control system operatively connected to the sensor and the pump; and
wherein the control system is configured to automatically perform at least one operational function based on data received from the sensor.

2. The system of claim 1, wherein the operational function includes activation of the pump.

3. The system of claim 1, wherein the operational function includes activation of a recirculation subsystem.

4. The system of claim 1, wherein the operational function includes activation of a heating system.

5. The system of claim 1, wherein the system maintains a continuous operational readiness state.

6. The system of claim 1, wherein the system performs periodic self-maintenance operations.

7. The system of claim 1, wherein the system transitions between multiple operational states.

8. The system of claim 1, wherein the sensor measures at least one of:
fluid level, temperature, pressure, flow rate and chemical composition.

9. The system of claim 1, wherein the control system determines a readiness state based on sensor data.

10. The system of claim 1, wherein the system generates an alert when a parameter exceeds a threshold.

11. The system of claim 1, wherein the system performs self-diagnostic operations.

12. The system of claim 1, wherein the system predicts maintenance requirements based on sensor data trends.

13. The system of claim 1, wherein operation is influenced by environmental conditions.

14. The system of claim 1, wherein the system optimizes usage of firefighting fluid based on available volume.

15. A fire suppression system comprising:
a reservoir containing firefighting fluid;
a pump configured to discharge the fluid;
a telemetry/control subsystem configured to communicate with an external system; and
wherein the telemetry/control subsystem transmits operational status data of the fire suppression system to an emergency response system.

16. The system of claim 15, wherein the system receives control commands from an emergency response authority.

17. The system of claim 15, wherein the system transmits geographic location data.

18. The system of claim 15, wherein the system is registered within a network of fire suppression systems.

19. The system of claim 15, wherein multiple systems are coordinated through the external system.

20. The system of claim 15, wherein the system is remotely activated during a fire event.

21. The system of claim 15, wherein the system transmits a readiness status.

22. The system of claim 15, wherein communication occurs via satellite, cellular, or wireless network.

23. The system of claim 15, wherein the system continues operation in absence of communication.

24. The system of claim 15, wherein the system provides visual or electronic signaling for emergency personnel.
